(19) United States
(12) Patent Application Publication
(10) Pub. No.: US 2022/0292850 A1
(43) Pub. Date: Sep. 15, 2022

(54) RESERVED SEAT MONITORING SYSTEM, RESERVED SEAT MONITORING METHOD, AND STORAGE MEDIUM

(71) Applicant: DENSO CORPORATION, Kariya-city (JP)

(72) Inventor: Hideo MUROI, Kariya-city (JP)

(21) Appl. No.: 17/804,042

(22) Filed: May 25, 2022

Related U.S. Application Data
(63) Continuation of application No. PCT/JP2020/042407, filed on Nov. 13, 2020.

(30) Foreign Application Priority Data
Nov. 26, 2019 (JP) 2019-213557

(51) Int. Cl. G06V 20/59; G06Q 10/02; G06T 7/70

(52) U.S. Cl. CPC G06V 20/59; G06Q 10/02; G06T 7/70; G06T 2207/30268

(57) ABSTRACT

In a reserved seat monitoring system, a control unit acquires image information of an angle of view including a seat of interest that is reserved and surrounding seats within a predetermined region based on the seat of interest, determines whether an object overlapping the seat of interest is present by using a result of analysis of the image information, and in a case where the object is determined to be present, calculates a probability that occupation of the object is resolved during a reservation changeable period for the seat of interest and when the calculated probability is lower than a predetermined value, notifies a change in reservation to a person reserving the seat of interest.

### CROSS-REFERENCE TO RELATED APPLICATION

The present application is based on and claims the benefit of priority from earlier Japanese Patent Application No. 2019-213557 filed Nov. 26, 2019, the description of which is incorporated herein by reference.

### BACKGROUND

### Technical Field

The present disclosure relates to a reserved seat monitoring system, a reserved seat monitoring method, and a storage medium that are used in, for example, a transport operation for transporting passengers to destinations, to monitor reserved seats for the passengers or the like.

### Related Art

In transportation facilities represented by buses and trains, passengers may reserve seats. A reserved seat management system and a seat reservation system are disclosed.

### SUMMARY

An aspect of a reserved seat monitoring system according to the present disclosure includes control unit acquiring image information of an angle of view including a seat of interest that is reserved and surrounding seats within a predetermined region based on the seat of interest, determining whether an object overlapping the seat of interest is present by using a result of analysis of the image information, and in a case where the object is determined to be present, calculating a probability that occupation of the object is resolved during a reservation changeable period for the seat of interest and when the calculated probability is lower than a predetermined value, notifying a change in reservation to a person reserving the seat of interest.

### BRIEF DESCRIPTION OF THE DRAWINGS

In the accompanying drawings:

FIG. 1A is a perspective view of the appearance of a community bus used as a mobile body according to an embodiment;

FIG. 1B is a plan view of a vehicle interior of the community bus used as a mobile body according to the embodiment;

FIG. 2 is a system configuration diagram including a reserved seat management system according to the embodiment;

FIG. 3A is a perspective view illustrating an image capture region of a camera directed toward seats on one side;

FIG. 3B is a plan view of the vehicle interior in which a pair of rows of seats is disposed;

FIG. 4 is a side view and a plan view illustrating a relationship between a pair of cameras and an image capture area according to the embodiment;

FIG. 5 is a functional block diagram illustrating processing executed by a seat monitoring control apparatus according to the embodiment and sorted by function;

FIG. 6A is a plan view illustrating a seated state of a physically large passenger partially occupying an adjacent seat;

FIG. 6B is a plan view illustrating baggage being placed in an adjacent seat;

FIG. 6C is a plan view illustrating a state in which baggage is protruding from a seated passenger;

FIG. 6D is a plan view illustrating a state in which an empty seat is dirty;

FIG. 7 is a front view of a portable terminal (smartphone) to which a message has been notified;

FIG. 8 is a flowchart of a reserved seat monitoring control routine executed by the seat monitoring control apparatus according to the embodiment;

FIG. 9 is a plan view of a vehicle according to Modified Example 1 (fixed arrangement of a plurality of cameras); and

FIG. 10 is a plan view of a vehicle according to Modified Example 2 (movement of a single camera along a rail).

### DETAILED DESCRIPTION OF THE PREFERRED EMBODIMENTS

In transportation facilities represented by buses and trains, passengers may reserve seats.

JP 1998-154246 A describes a reserved seat management system including a sensing means for sensing whether each seat is occupied, a storage means for storing reservation information for each seat, a search means for searching for empty seat information for each seat stored by the storage means, an input means for receiving occupied seat information detected by the detection means, a matching means for matching the empty seat information against the occupied seat information, a change means for changing the empty seat information, a search means for searching for seat information as changed by the change means, a matching means for matching the empty seat information searched for by the search means against the occupied seat information received by the input means, a detection means detecting whether the availability of the seat is correct from the matching information resulting from the matching performed by the matching means, and a display means for displaying correct-or-incorrect information detected by the detection means.

According to JP 1998-154246 A, automation of checks for tickets for reservation can be achieved without card readers, reducing the costs of the system, and this technique also allows quick detection of whether the availability of each reserved seat is correct and quick display of correct-or-incorrect information, the detection and display being associated with the automation.

Additionally, for reference, JP 2014-174706 A describes a seat reservation system enabling, for internet reservation outside business hours (offline time), determination of whether a seat can be reserved.

JP 1998-154246 A does not consider how to deal with a case where a passenger reserving one of adjacent seats is seated earlier and has such a physique that armrests and the like located between the seats are obstacles to the passenger, thus cramping the other seat. In particular, JP 1998-154246 A only provides information indicating whether passengers are correctly seated.

Additionally, when the passenger seated earlier places baggage (suitcase or the like) in the adjacent seat and occupies the seat, the passenger may cause trouble with a passenger coming later.

Moreover, in a case where a reserved seat is dirty, the passenger is essentially prevented from being seated.

If a conductor is available, the trouble and the like can be settled but fail to be prevented. On the other hand, no conductor may be available in a driverless, self-driving vehicle.

An object of the present disclosure is to provide a reserved seat monitoring system, a reserved seat monitoring method, and a storage medium storing a reserved seat monitoring program that allow unnecessary problems to be avoided by recognizing the status of a reserved seat before a passenger reserving the seat sits and notifying the status to the person having a reservation.

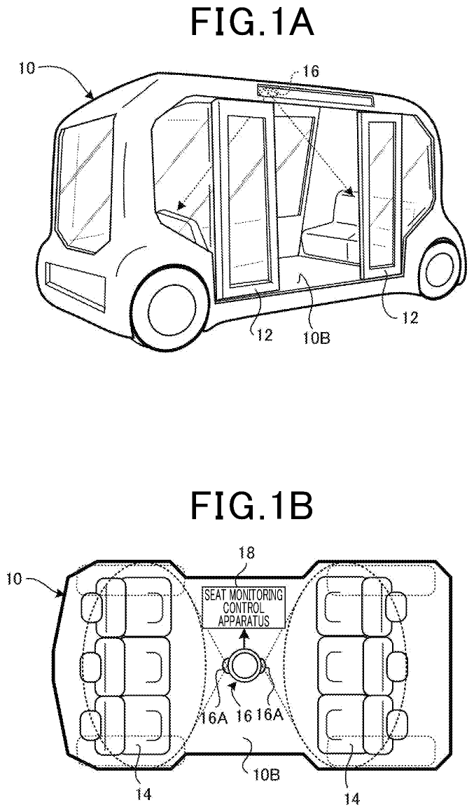

FIGS. 1A and 1B illustrate a community bus 10 used as a mobile body according to the present embodiment.

The community bus 10 often refers to a bus that is small (fewer passengers) compared to an ordinary local bus and that travels around a relatively short distance and is thus utilized as a means for transportation for local residents. However, the community bus 10 has no particular definition.

The community bus 10 applied to the present embodiment is a small mobile body that travels around along a predetermined route and that has a capacity of six persons, and is automatically operated. The automatic operation corresponds to a system equipped with AI (Artificial Intelligence) that performs machine learning based on image information obtained by a camera provided in the bus and image information received from a camera installed on a surrounding road and cameras mounted in vehicles traveling around the community bus 10, a large amount of aggregated image information, and the like, thus automatically navigating its way along general roads instead of having a human driver. The present embodiment assumes an automatic operation at level 4 (fully automatic operation under particular conditions) or higher.

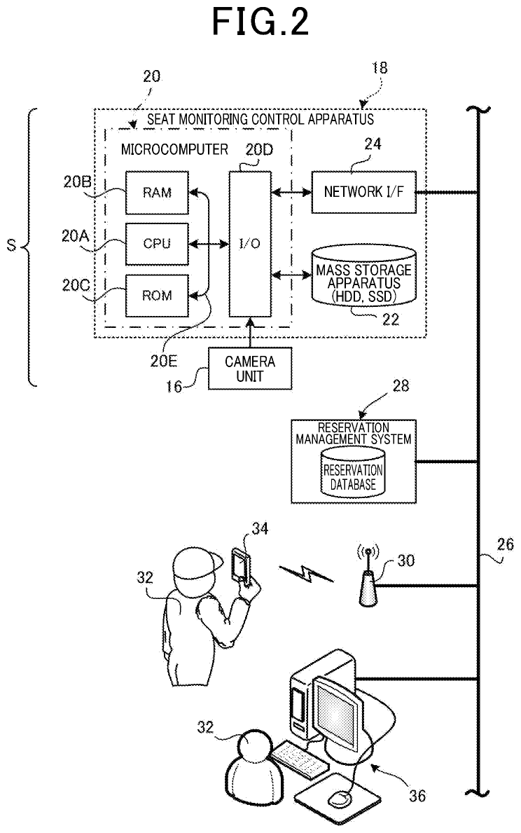

The community bus 10 travels along a route on which a plurality of passing points are set between a start point and an end point, and can be taken by persons reserving seats in advance by using a reserved seat management system S (see FIG. 2).

The reserved seat management system is a well-known technique, and thus detailed description of the system is omitted. The reserved seat management system is configured to acquire, at the time of reservation, identification information enabling identification of a person reserving a seat.

A person having a reservation goes to a bus stop corresponding to the start point reserved by the person and waits for the community bus 10, and can then take the community bus 10.

As illustrated in FIG. 1A, the community bus 10 is provided with a slide door 12 in the middle of a side surface. An operation for opening and closing the door 12 is controlled as an automatic operation.

As illustrated in FIG. 1B, in the vehicle interior of the community bus 10, sets of seats 14 each for three persons are disposed facing each other, and between the pair of sets of seats 14, an area is located in which a person boards the bus when the door 12 is opened. After boarding the bus, the person sits in one of the right or left set of seats reserved by the person.

In this regard, the community bus 10 according to the present embodiment is equipped with the reserved seat management system S (see FIG. 2) for monitoring the seated state of the set of seats 14. The reserved seat management system S includes a camera unit 16 used as a state detection unit and a seat monitoring control apparatus 18.

The camera unit 16 detects objects including passengers in the vehicle interior of the community bus 10.

As illustrated in FIG. 2, the seat monitoring control apparatus 18 includes a microcomputer 20 for analyzing an object detected by the camera unit 16. The microcomputer 20 includes a CPU 20A, a RAM 20B, a ROM 20C, an input/output unit (I/O) 20D, and a bus 20E such as a database or a control bus which connects the CPU 20A, RAM 20B, ROM 20C, and input/output unit (I/O) 20D together.

The I/O 20D connects to the camera unit 16 and a mass storage device 22 such as an HDD or an SSD. Additionally, the I/O 20D connects to a network 26 such as the Internet via a network I/F 24.

Note that in the present embodiment, the community buses 10 are each equipped with the seat monitoring control apparatus 18 and are individually controlled but that in a case where, for example, a high-speed communication network such as 5G is available, then with the community bus 10 provided with a terminal apparatus including only an input/output device and a communication function, a management server (not illustrated) may collectively perform seat management control (processing executed by the microcomputer 20) on all the community buses 10.

The network 26 connects to a reservation management system 28 for reserving a seat in the community bus 10 and a wireless transmission facility 30 capable of wireless communication.

The network 26 can connect to a portable terminal (smartphone) 34 and a PC 36 owned by a person who may be a passenger 32, and the portable terminal 34 and the PC 36, for example, accesses the reservation management system 28 and reserves a seat in the desired community bus 10. The reservation management system 28 includes a reservation database 28A in which reservation management information (information including client identification information and reservation information associated with each other) is stored.

### (Camera Unit 16)

The camera unit 16 used as a state detection unit is attached to a ceiling surface of the vehicle interior of the community bus 10 according to the present embodiment.

A pair of cameras 16A is attached to the camera unit 16, and the optical axes of the cameras 16A are aligned in opposite directions (in plan view) and obliquely downward to capture images of the pair of sets of seats 14.

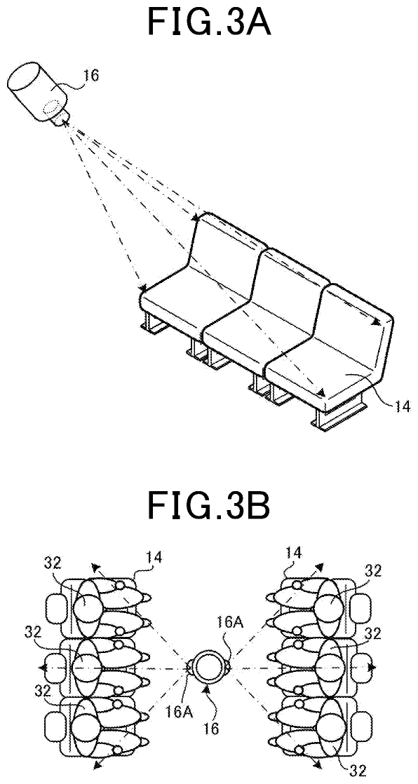

FIG. 3A illustrates an image capture region of the camera 16A directed toward one of the sets of seats 14, enabling an image of the entire set of seats 14 (seat surface and rear surface) to be captured.

Consequently, as illustrated in FIG. 3B, when the community bus 10 is fully occupied, images of six passengers 32 can be captured.

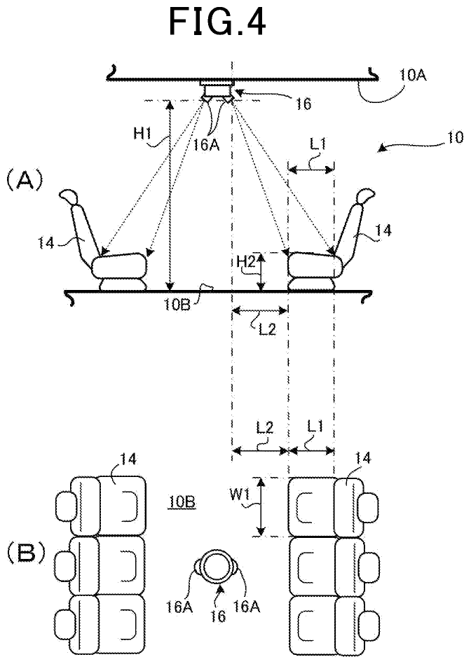

FIG. 4 illustrates a relationship between the pair of cameras 16A and the image capture area.

Description will be given of the angle of view for taking images of the pair of sets of seats 14 installed on a floor surface 10B by using the pair of cameras 16A on the ceiling surface 10A of the community bus 10.

First, a vertical angle of view θ1 and a horizontal angle of view θ2 need to allow an image of the entire seat surface of the seat 14 to be captured.

In the relationship between the camera 16A and the community bus 10 in the present embodiment, the vertical angle of view θ1 is determined as below. In this regard, the camera 16A and the seat 14 are assumed to face each other.

The vertical angle of view θ1 is given by:

θ1=arc tan((L2+L1)/(H1−H2))−arc tan(L2)/(H1−H2)=arc tan((1+0.5)/(3−0.5))−arc tan(1)/(3−0.5)≅9.16°

wherein H1 denotes the installation height of the camera 16A (here, 3 m), H2 denotes a height from the floor surface 10B to the seat surface of the seat 14 (here, 0.5 m), L1 denotes the length (depth) of the seat surface of the seat 14 (here, 0.5 m), and L2 denotes a distance from the camera 16A to the seat 14 (leading end of the seat surface) (here, 1 m).

On the other hand, in the relationship between the camera 16A and the community bus 10 in the present embodiment, the horizontal angle of view θ2 is determined as below. The horizontal angle of view θ2′ for one seat is given by:

θ2′=arc tan((W1/2)/(L2))×2=arc tan((0.5/2)/(1))×2≅28.1°

where in addition to the above-described dimensions, W1 denotes the width of one seat in the set of seats 14 (here, 0.5 m).

In the present embodiment, three seats are arranged in one row, and thus the horizontal angle of view θ2 of the set of seats 14 is given by:

θ2′=arc tan((W1×3/2)/(L2))×2=arc tan((1.5/2)/(1))×2≅73.7°

As described above, the camera 16A mounted in the community bus 10 can capture an image of the entire set of seats 14 when the camera 16A is installed such that the vertical angle of view θ1 is 9.16° and that the horizontal angle of view θ2 is 73.7°.

Note that in the present embodiment, the camera 16A is applied as the state detection unit but that the state detection unit is not limited to the camera 16A and that any device such as a millimeter-wave radar or a LIDAR can be used as the state detection unit as long as the device can detect an object.

Additionally, as the state detection unit, the device represented by the camera 16A is illustrated that can recognize the status of the predetermined region around the set of seats 14 (reference). However, from another point view, a device may be used that detects a load on the seat 14.

A piezoelectric element (not illustrated) is an example of the device detecting the load on the seat 14.

For example, a state similar to that in the image captured by the camera 16A can be detected by embedding a plurality of piezoelectric elements in the seat surface and a backrest of the seat 14, creating a pressure distribution chart from differences between signals (voltage values and the like) from the piezoelectric elements, and expressing the pressure distribution in approximately 8 bits rather than in binary values. The pressure distribution of the buttocks of the passenger 32 as seated, detected by the piezoelectric elements, can be converted into the shoulder width of the passenger 32, obtaining the physique of the passenger 32.

Now, the seat monitoring control device 18 according to the present embodiment (see FIGS. 1A, 1B, and 2) acquires image information from the pair of cameras 16A, analyzes and sorts the image information into the set of seats 14, the passengers 32, and other objects (articles, background, and the like), and for example, calculates the occupancy of the passenger seated in one seat.

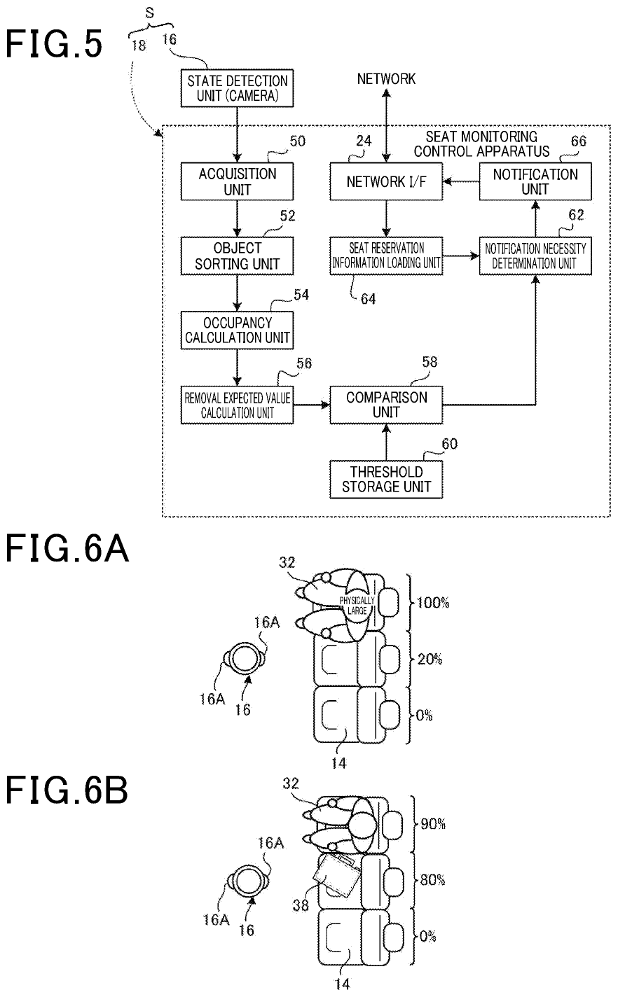

FIG. 5 is a functional block diagram illustrating processing executed by the seat monitoring control device 18 and sorted by function. Note that the blocks are not intended to limit the hardware configuration executing each function. All the functions may be executed as a software program by the CPU 20A (computer) of the seat monitoring control device 18, or IC chips such as ASICs for the different functions may be integrated into the CPU 20A. The software program is stored in the mass storage device 22 (storage medium).

The camera unit 16 (that is, in this case, the pair of cameras 16A) is connected to the acquisition unit 50. The acquisition unit 50 acquires image information from the pair of cameras 16A.

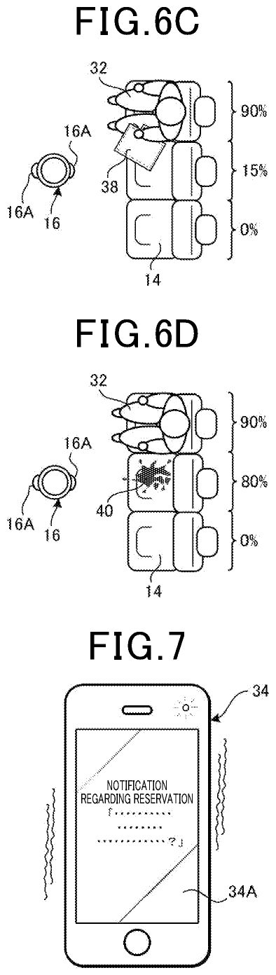

The image information acquired by the acquisition unit 50 is transmitted to an object sorting unit 52, which sorts the image information into various objects (the set of seats 14, the passengers 32, the baggage 38, and contaminants 40, and the like illustrated in FIGS. 6A to 6D).

### “Details of Object Sorting Unit 52”

Two examples of techniques for sorting, into objects, the image information obtained by the camera 16A will be described below. A first example is “extraction based on background differences,” and a second example is “extraction based on semantic segmentation.”

### FIRST EXAMPLE

### Extraction Based on Background Differences

Image information of the set of seats 14 is acquired in advance and stored as a background image. A difference between the background image and the current capture image information is determined, allowing a difference image (object) to be obtained. Additionally, a comparison between the set of seats 14 and the difference image (object) allows the size of the object to be recognized.

For recognition of the object based on the difference image, a machining learning means can be used such as a neural network or pattern recognition using supervised learning (SVM “Support Vector Machine”).

### SECOND EXAMPLE

### Extraction Based on Object Detection

Additionally, object detection is known as a technique for directly determining what appears in which part of one frame image information. Object detection is mainly performed using a Deep Neural Network (DNN), which includes SSD, Yolo, M2Det, and the like, and allows the footprint of an object to be obtained by using a “bounding box” corresponding to a rectangle surrounding the presence of the object. Note that this technique is not limited to three-dimensional objects and that contaminant on the seat 14 can be recognized as a “bounding box.”

### THIRD EXAMPLE

### Extraction Based on Semantic Segmentation

Semantic segmentation is a technique for sorting pixels into different class attributes.

For example, this technique sorts a given image into attributes (for example, a human being, a road, a car, a tree, a building, a sign, and the like), and by applying the technique to the vehicle interior of the community bus 10, the image can be sorted into the set of seats 14, the passenger 32, and the baggage 38 carried by the passenger 32. Additionally, the contaminant on the seat 14 can be sorted depending on the color.

As illustrated in FIG. 5, the object sorting unit 52 is connected to an occupancy calculation section 54. The occupancy calculation section 54 calculates the occupancy of an object to be monitored, using one seat as a reference.

The object to be monitored may be a part of the adjacent seat that is occupied by the passenger 32 seated in a case where the passenger 32 is relatively physically large, the baggage 38 placed in the adjacent seat by the passenger 32, the contaminant 40 attached to the seat 14, or the like.

### “Details of Occupancy Calculation Unit 54”

The occupancy is calculated using two types of equations below ((Equation 1) and (Equation 2)), and the larger value obtained is adopted.

(1) Occupancy=(occupied length in seat width direction)/(length in seat width direction) Equation 1

(2) Occupancy=(occupied part of seat area)/(seat area) Equation 2

Note that since the community bus 10 is traveling, the calculation result for the occupancy calculated by the occupancy calculation unit 54 may include an error attributed to an image processing algorithm, an error attributed to movement of the passenger 32 or the baggage 38, and an error attributed to swinging of the camera 16A.

Thus, for the calculation of the occupancy, the error is preferably reduced by taking the average or median at prescribed time intervals after a predetermined time period has elapsed since the departure from the bus stop (including the start point).

As illustrated in FIG. 5, the occupancy calculation unit 54 is connected to a removal expected value calculation unit 56. The removal expected value calculation unit 56 calculates an expected value indicating whether the occupancy calculated by the occupancy calculation unit 54 is improved over time (whether the occupancy remains unchanged or reduced)

### “Details of Removal Expected Value Calculation Unit 56”

A removal expected value is intended to distinguish a case of contaminant on the seat 14 or the like for which the occupancy is not expected to be improved in a short time from a case of the baggage 38 placed in the adjacent seat or the like for which the occupancy is expected to be improved in a short time.

A calculation formula is set to represent the removal expected value as a numerical value ranging from 0 to 1.

A removal expected value of 1 means that the object is reliably removed before the passenger 32 having a reservation sits in the reserved seat for which the occupancy is calculated.

A removal expected value of 0 means that the object is unlikely to be removed before the passenger 32 having a reservation sits in the reserved seat for which the occupancy is calculated.

### (Case of Over-Occupancy by Passenger 32)

The removal expected value for the passenger 32 is calculated using 1−(occupancy×R1).

In this case, R1=0 in a case where the passenger 32 seated reserves the same route as that reserved by the passenger coming later, and R1=1 in a case where the passenger 32 seated does not reserve the same route as that reserved by the passenger coming later.

Note the passenger seated earlier, who is physically large, may hunch the shoulders and thus that R1 may be a decimal value between 0 and 1. Additionally, for example, based on boarding history information for the physically large passenger, and the like, the passenger (identification information) and the coefficient R1 may associated with each other for storage.

### (Case of Baggage 38)

A removal expected value for the baggage 38 is calculated using 1−(occupancy×R2×object type coefficient×position coefficient).

However, in a case where passengers 32 are respectively seated on opposing sides of the seat in which the baggage 38 is placed, R2=0 when neither of the passengers 32 seated on both sides reserves the same route as that reserved by the passenger coming later, R2=0.5 when one of the passengers seated on both sides reserves the same route, and both passengers 32 respectively seated on opposing sides reserve the same route.

Additionally, in a case where a passenger 32 is seated on one side of the seat in which the baggage 38 is placed, R2=0 when the passenger 32 seated does not reserve the same route as that reserved by the passenger coming later, and R2=1 in a case where the passenger 32 seated reserves the same route as that reserved by the passenger coming later.

Note that the object type coefficient is defined according to the ease with which the baggage 38 can be removed. For example, a bag has an object type coefficient of 0.5, cardboard sheets have an object type coefficient of 0.8, and a suitcase has an object type coefficient of 0.9.

Additionally, the position coefficient is used to distinguish the seat surface of the seat 14 from the floor surface in front of the seat 14. For example, the seat surface has a position coefficient of 0.8, and the floor surface has a position coefficient of 1.

### (Case of Contaminant 40)

A removal expected value for the contaminant 40 is calculated using 1−(occupancy×R3).

In this case, R3=0 in a case where the community bus 10 is scheduled to be cleaned before the seat 14 is reserved, and R3=1 in a case where the community bus 10 is not scheduled to be cleaned before the seat 14 is reserved

In other words, in a case where the cleaning schedule is known, the removal expected value can be increased according to the timing of the cleaning.

Note that R3=0 in a case where the cleaning schedule is unknown. Moreover, R3=1 can be set in a case where instead of the cleaning schedule, an urgent cleaning instruction can be given.

As illustrated in FIG. 5, the removal expected value calculation unit 56 is connected to a comparison unit 58. The comparison unit 58 is configured to read, from a threshold storage unit 60, a threshold to be compared with the removal expected value and to compare the threshold with the removal expected value received from the removal expected value calculation unit 56.

The threshold stored in the threshold storage unit 60 is adjustable, and may be set to 1 in order to reliably prevent a trouble between passengers that is related to the occupancy of seats.

A case where the threshold is set to a value other than 1 will be discussed based on existing traffic vehicles.

The shoulders have the largest width among the body parts of a human being, and the average shoulder width of male adults is 45.6 cm, with a standard deviation σ of 1.45 cm.

In this regard, in railroad vehicles, which are representative means for transportation, for example, in E231 series vehicles of East Japan Railway Company, the seat width W1 is 45 cm, and in E235 series vehicles, the seat width W1 is 46 cm.

Given that the E231 series vehicles are designed to allow for up to the average of the shoulder width+2σ, 45.6+1.45×2−45=3.5, and the occupancy of the adjacent seat caused by the passenger 32 partially occupying the adjacent seat is 3.5/45≅0.078 (7.8%). In other words, the allowable region of occupancy of the adjacent seat is up to 7.8%.

On the other hand, given that the E335 series vehicles are designed to allow for up to the average of the width+2σ, 45.6+1.45×2−46=2.5, and the occupancy of the adjacent seat caused by partial occupancy by the passenger 32 is 2.5/45≅0.054 (5.4%). In other words, the allowable region of occupancy of the adjacent seat is up to 5.4%.

As described above, the allowable value of the occupancy in a design stage can be estimated using the seat width W1 and the shoulder width. By enabling the allowable value of the occupancy to be estimated, the threshold for the removal expected value can be set to 0.922 for the E231 series vehicles, to 0.946 for the E235 series vehicles, and the like based on 1−occupancy.

Additionally, for a sufficient margin, the removal expected value may be designed using the set occupancy as a lower limit value.

As illustrated in FIG. 5, the comparison unit 58 is connected to a notification necessity determination unit 62. Additionally, a seat reservation information loading unit 64 is connected to the notification necessity determination unit 62. The seat reservation information loading unit 64 loads reservation information for the concerned seat from the reservation management system 28 (see FIG. 2) via the network I/F 24, and transmits the reservation information to the notification necessity determination unit 62.

The notification necessity determination unit 62 determines whether to provide notification (as examples, a suggestion for a change of reservation to another service, a suggestion for a change of reservation to an empty seat in the same service) to the person reserving the seat concerned from a comparison result from the comparison unit 58, that is, a result based on the removal expected value and indicating whether there is a problem with the availability of the seat, and the reservation information on the concerned seat.

In response to determining that the notification is needed, the notification necessity determination unit 62 instructs a notification unit 66 to provide notification. The notification unit 66 provides notification via the network I/F 24 to the portable terminal 34 or the PC 36 owned by the person having a reservation.

For the notification, for example, a message is transmitted to a mail address registered as identification information identifying the person having a reservation and acquired when the person having a reservation reserves the seat using the reservation management system 28. The transmission of the message causes the notification to be informed (output of a ringtone, a vibration operation, or the like) at the portable terminal 34 or the PC 36.

As an example of the message, as illustrated in FIG. 7, a display screen 34A of the portable terminal 34 (smartphone or the like) displays a message entitled “Notification regarding Reservation”: “The reserved vehicle is currently crowded. Another service with substantially the same arrival time is relatively uncrowded. Would you like to change the reservation?” or “Many of the seats surrounding the reserved seat are occupied. There is a comfortably available seat slightly away from the reserved seat. Would you like to change the reservation?” Note that at the time of the notification, the type of the object causing the problem may be notified. Additionally, an image of the object causing the problem may be attached to the message.

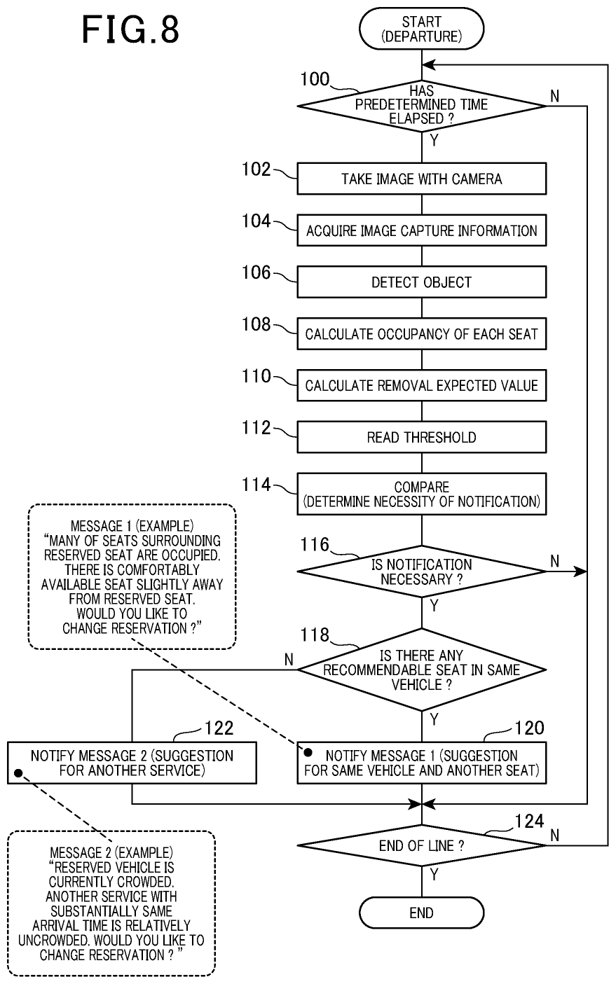

The effects of the present embodiment will be described in accordance with a flowchart in FIG. 8.

The flowchart in FIG. 8 is initiated when the community bus 10 is started. First, in step 100, whether a predetermined time period has elapsed since the start of the community bus 10 is determined.

In response to negative determination in step 100, the routine proceeds to step 124 to determine whether the community bus 10 has arrived at the end of the line. In response to affirmative determination, the routine ends. Additionally, in response to negative determination in step 124, the routine returns to step 100.

In response to affirmative determination in step 100, the routine proceeds to step 102, where the camera unit 16 captures images. The routine then proceeds to step 104.

In step 104, the seat monitoring control device 18 acquires image information obtained, and the routine proceeds to step 106 to sort objects based on the image information. The routine then proceeds to step 108.

In step 108, the occupancy of each seat of the set of seats 14 is calculated, and then the routine proceeds to step 110 to calculate the removal expected value. The routine then proceeds to step 112.

In step 112, the threshold is read out, and the routine proceeds to step 114 to compare the removal expected value calculated in step 110 with the threshold read out in step 112 and determine a result of the comparison (necessity of notification). The routine then proceeds to step 116.

In step 116, whether the determination result in step 114 indicates the necessity of notification is determined.

In response to affirmative determination (the notification is determined to be necessary) in step 116, the routine proceeds to step 118 to determine whether the same vehicle (same community bus 10) includes any recommendable seat.

In response to affirmative determination in step 118, the routine proceeds to step 120 to notify message 1 as a suggestion for the same vehicle and another seat, and then proceeds to step 124.

An example of message 1 is “Many of the seats surrounding the reserved seat are occupied. There is a comfortably available seat slightly away from the reserved seat. Would you like to change the reservation?”

Additionally, in response to negative determination in step 118, the routine proceeds to step 122 to notify message 2 as a suggestion for another service, and then proceeds to step 124.

An example of message 2 is “The reserved vehicle is currently crowded. Another service with substantially the same arrival time is relatively uncrowded. Would you like to change the reservation?”

On the other hand, in response to negative determination (the notification is determined to be unnecessary) in step 116, the routine proceeds to step 124.

In step 124, whether the community bus 10 has arrived at the end of the line is determined, and in response to affirmative determination, the routine ends. Additionally, in response to negative determination in step 124, the routine returns to step 100.

As described above, in the present embodiment, until before the passenger reserving a seat in the community bus 10 boards the community bus 10, the camera unit 16 captures an image of the current status of the reserved seat, whether any object is present on the seat is determined, the occupancy of the object is calculated, and the expected value is calculated that indicates that the object occupying the seat may be removed before the passenger boards the community bus 10. Thus, a proper message can be notified to the passenger who is to board the community bus 10, inhibiting possible problems between the passengers.

Note that the procedure in the flowchart in FIG. 8 is illustrative and that at least a basic procedure can preferably be executed that includes sorting objects in the captured image, calculating the occupancy of the seat occupied by a particular object, and based on the removal expected value for the object, determining whether to notify an alternative suggestion to the person having a reservation and not being seated yet. Some of the processing operations may be executed in a different order or at different processing timings.

### MODIFIED EXAMPLES

Note that in the present embodiment, the community bus 10, which is automatically operated, has been described as an example but automatic operation is not essential and the present embodiment is applicable to reservation monitoring in existing transit buses, sight seeing buses, and trains despite the presence of crew as long as the mobile pair avoids possible problems between the passengers. Modified examples of the present embodiment will be described below taking, as an example, a mobile body (bus or train) including sets of seats 14 for more passengers than the community bus 10.

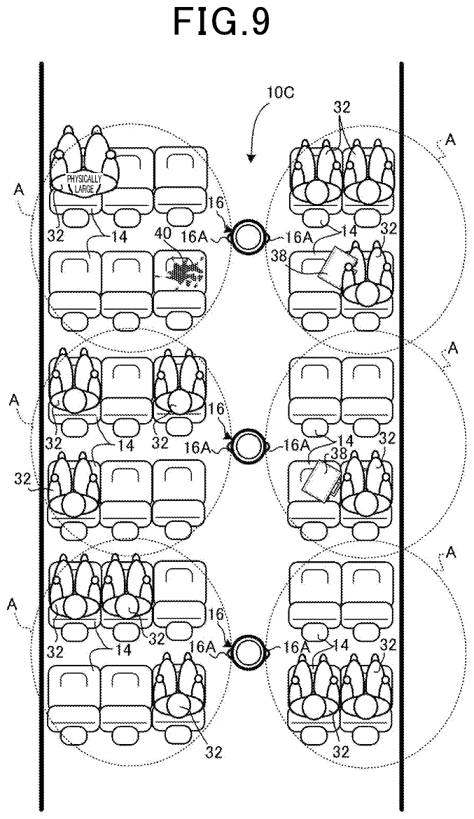

Modified Example 1 will be described with reference to FIG. 9. In Modified Example 1, the seats 14 are arranged on the floor surface 10B all facing in the same direction, and sets of three seats 14 are arranged on the left side of a central aisle 10C, whereas sets of two seats 14 are arranged on the right side of the central aisle 10C. In other words, the seats are arranged such that one row in the vehicle includes five seats.

A plurality of camera units 16 are mounted above the aisle 10C (on the ceiling surface), and the paired cameras 16A of the camera unit 16 are respectively directed toward the sets of three seats 14 and the sets of two seats 14.

Specifically, one camera unit 16 captures images of two rows of seats 14 (total of ten seats).

The image taking direction is lateral to the seats 14, but images of the ten seats 14 can be captured with substantially no blind spot (see dotted lines A in FIG. 9) as long as the camera unit 16 is mounted at a sufficient height from the floor surface 10B.

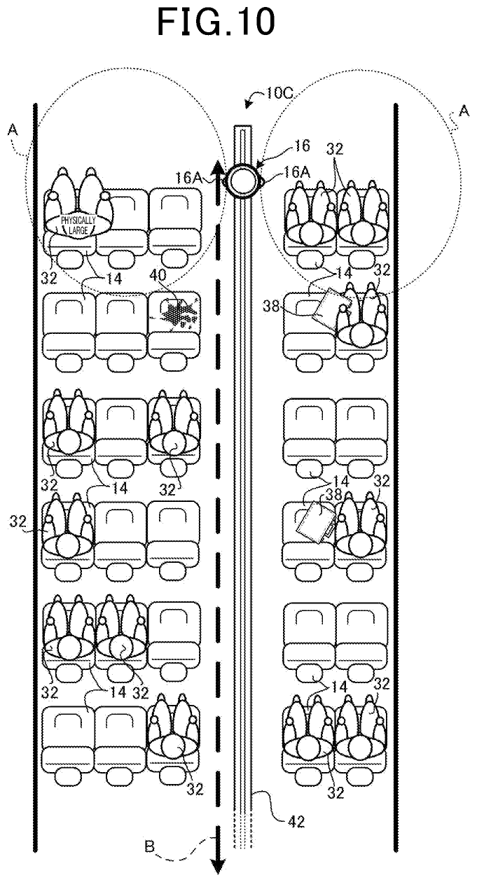

Modified Example 2 will be described with reference to FIG. 10. In Modified Example 2, the seats 14 are arranged on the floor surface 10B all facing in the same direction, and sets of three seats 14 are arranged on the left side of the central aisle 10C, whereas sets of two seats 14 are arranged on the right side of the central aisle 10C. In other words, the seats are arranged such that one row in the vehicle includes five seats.

A rail 42 is mounted above the isle 10C (on the ceiling surface) along a front-back direction of the mobile body. One camera unit 16 is attached to the rail 42. The paired cameras 16A of the camera unit 16 are respectively directed toward the sets of three seats 14 and the sets of two seats 14. The camera unit 16 can move along the rail 42 (see dotted arrow B in FIG. 10), and the single camera unit 16 captures images of all the rows of seats 14 while moving along the rail 42.

The image taking direction is lateral to the seats 14, but images of the ten seats 14 can be captured with substantially no blind spot (see dotted lines A in FIG. 10) as long as the camera unit 16 is mounted at a sufficient height from the floor surface 10B.

Note that in a case where the reserved seat management system S according to the present embodiment is used to discover the contaminant 40, an alert for urgent cleaning may be issued in addition to periodic cleaning to dispatch a cleaner to the nearest bus stop. Additionally, in a case where the owner of the baggage 38 in the empty seat is clearly known, the owner may be notified through in-vehicle announcement before the passenger 32 who is to sit in the empty seat boards the vehicle.

Although the present disclosure has been described based on the embodiments, it is to be understood that the disclosure is not limited to the embodiments and configurations. This disclosure encompasses various modifications and alterations falling within the range of equivalence. Additionally, various combinations and forms as well as other combinations and forms with one, more than one, or less than one element added thereto also fall within the scope and spirit of the present disclosure.

An aspect of a reserved seat monitoring system according to the present disclosure includes control unit (18) acquiring image information of an angle of view including a seat of interest that is reserved and surrounding seats within a predetermined region based on the seat of interest, determining whether an object overlapping the seat of interest is present by using a result of analysis of the image information, and in a case where the object is determined to be present, calculating a probability that occupation of the object is resolved during a reservation changeable period for the seat of interest and when the calculated probability is lower than a predetermined value, notifying a change in reservation to a person reserving the seat of interest.

An aspect of a reserved seat monitoring system according to the present disclosure includes a reservation unit (28) reserving a seat; a storage section (28A) storing reservation information regarding the reservation made by the reservation unit; an acquisition unit (50) acquiring the reservation information stored; an image capturing unit (16) disposed at a position from where a plurality of seats and the seat are visible; an extraction unit (52) extracting, from the image information obtained by the image capturing unit, a type of an object other than the seats which are present around the seats, a position of the object, and a size of the object; a first calculation unit (54) calculating a proportion of a part of each seat occupied from the object position and size extracted by the extraction unit; a second calculation unit (56) calculating a probability that the object extracted by the extraction unit will be removed, based on the proportion of a part of each seat occupied by the object and the reservation information obtained from the acquisition unit; and a notification unit (58, 60, 62, 66) providing, in a case where the probability calculated by the second calculation unit is lower than a predetermined value, notification to a person reserving the seat for which the probability is lower than the predetermined value.

An aspect of a reserved seat monitoring method according to the present disclosure includes acquiring image information of an angle of view including a seat of interest that is reserved and surrounding seats within a predetermined region based on the seat of interest, determining whether an object overlapping the seat of interest is present by using a result of analysis of the image information, and in a case where the object is determined to be present, calculating a probability that occupation of the object is resolved during a reservation changeable period for the seat of interest and when the calculated probability is lower than a predetermined value, notifying a change in reservation to a person reserving the seat of interest.

An aspect of a reserved seat monitoring method according to the present disclosure includes reserving a seat; storing reservation information regarding the reservation; acquiring the reservation information stored; extracting, from image information obtained by an image capturing unit disposed at a position where a plurality of seats and the seat are visible, a type of an object other than the seats which are present around the seats, a position of the object, and a size of the object; calculating a proportion of a part of each seat occupied from the object position and size extracted, calculating a probability that the object extracted will be removed based on the proportion of a part of each seat occupied by the object and the reservation information acquired; and in a case where the probability calculated is lower than a predetermined value, providing notification to a person reserving the seat for which the probability is lower than the predetermined value.

An aspect of a storage medium stores a reserved seat monitoring program for causing a computer to function as each unit of the reserved seat monitoring system.

According to the present disclosure, unnecessary problems can be avoided by recognizing the status of a reserved seat before a passenger reserving the seat sits and notifying the status to the person having a reservation.

What is claimed is:

1. A reserved seat monitoring system comprising:
a control unit acquiring image information of an angle of view including a seat of interest that is reserved and surrounding seats within a predetermined region based on the seat of interest, determining whether an object overlapping the seat of interest is present by using a result of analysis of the image information, and in a case where the object is determined to be present, calculating a probability that occupation of the object is resolved during a reservation changeable period for the seat of interest and when the calculated probability is lower than a predetermined value, notifying a change in reservation to a person reserving the seat of interest.

2. A reserved seat monitoring system comprising:
a reservation unit reserving a seat;
a storage section storing reservation information regarding the reservation made by the reservation unit;
an acquisition unit acquiring the reservation information stored;
an image capturing unit disposed at a position from where a plurality of seats and the seat are visible;
an extraction unit extracting, from the image information obtained by the image capturing unit, a type of an object other than the seats which are present around the seats, a position of the object, and a size of the object;
a first calculation unit calculating a proportion of a part of each seat occupied from the object position and size extracted by the extraction unit;
a second calculation unit calculating a probability that the object extracted by the extraction unit will be removed, based on the proportion of a part of each seat occupied by the object and the reservation information obtained from the acquisition unit; and
a notification unit providing, in a case where the probability calculated by the second calculation unit is lower than a predetermined value, notification to a person reserving the seat for which the probability is lower than the predetermined value.

3. The reserved seat monitoring system according to claim 1, wherein
the object includes a passenger in an adjacent seat, baggage, and contaminant in the seat.

4. The reserved seat monitoring system according to claim 2, wherein
the object includes a passenger in an adjacent seat, baggage, and contaminant in the seat.

5. The reserved seat monitoring system according to claim 1, wherein
the notification includes the type of the object.

6. The reserved seat monitoring system according to claim 2, wherein
the notification includes the type of the object.

7. The reserved seat monitoring system according to claim 1, wherein
the notification includes the image information.

8. The reserved seat monitoring system according to claim 2, wherein
the notification includes the image information.

9. The reserved seat monitoring system according to claim 1, wherein
the notification includes a suggestion for a change to a seat having a probability of at least a predetermined value.

10. The reserved seat monitoring system according to claim 2, wherein
the notification includes a suggestion for a change to a seat having a probability of at least a predetermined value.

11. A reserved seat monitoring method comprising:
acquiring image information of an angle of view including a seat of interest that is reserved and surrounding seats within a predetermined region based on the seat of interest, determining whether an object overlapping the seat of interest is present by using a result of analysis of the image information, and in a case where the object is determined to be present, calculating a probability that occupation of the object is resolved during a reservation changeable period for the seat of interest and when the calculated probability is lower than a predetermined value, notifying a change in reservation to a person reserving the seat of interest.

12. A reserved seat monitoring method comprising:
reserving a seat;
storing reservation information regarding the reservation;
acquiring the reservation information stored;
extracting, from image information obtained by an image capturing unit disposed at a position where a plurality of seats and the seat are visible, a type of an object other than the seats which are present around the seats, a position of the object, and a size of the object;
calculating a proportion of a part of each seat occupied from the object position and size extracted,
calculating a probability that the object extracted will be removed based on the proportion of a part of each seat occupied by the object and the reservation information acquired; and
in a case where the probability calculated is lower than a predetermined value, providing notification to a person reserving the seat for which the probability is lower than the predetermined value.

13. A storage medium that stores a reserved seat monitoring program for causing a computer to function as each unit of the reserved seat monitoring system according to claim 1.

14. A storage medium that stores a reserved seat monitoring program for causing a computer to function as each unit of the reserved seat monitoring system according to claim 2.
